(19) United States
(12) Patent Application Publication
(10) Pub. No.: US 2005/0253993 A1
(43) Pub. Date: Nov. 17, 2005

(54) Flat panel display and assembly process of the flat panel display

(76) Inventors: Yi-Ru Chen, Kaohsiung City (TW); Hui-Chang Chen, Kaohsiung City (TW); Chun-Yu Lee, Sinying City (TW)

Correspondence Address: David I. Roche;BAKER & McKENZIE, 130 E. Randolph Drive, Chicago, IL, 60601, US

(21) Appl. No.: 10/843,605

(22) Filed: May 11, 2004

(51) Int. Cl. G02F 1/1345

(52) U.S. Cl. 349/152

(57) ABSTRACT

In a flat panel display, a plurality of scan, data driver integrated circuit chips are attached via anisotropic conductive films to the connection terminals of the scan and data lines of the pixel array. Interface layers are formed in areas of the array substrate located between two neighboring driver chips so as to improve the adhesion of the anisotropic conductive films to the array substrate.

### BACKGROUND OF THE INVENTION

1. Field of the Invention

This invention generally relates to the field of flat panel display manufacture, and more particularly to a flat panel display and an assembly process that can improve the assembly of driver chips in the flat panel display.

2. Description of the Related Art

FIG. 1A is a schematic view illustrating a portion of a conventional pixel array implemented in a liquid crystal display (LCD) system known in the art. Conventionally, a LCD panel 100 includes a mesh of scan, data lines 112, 114 configured to form an array of pixels 120. In each pixel 120, a switching device 130 couples one pixel electrode 122 with one scan line 112 and one data line 114, respectively. The array of pixels 120 is formed in a display area 150 of the LCD panel 100.

In a peripheral non-display area 160, the scan, data lines 112, 114 terminate in connection terminals 170a, 170b dedicated to the electrical connection with scan, data driver chips 180a, 180b (shown in FIG. 1B), respectively. Conventionally, the scan, data driver chips 180a, 180b are electrically connected to the connection terminals 170a, 170b by means of an anisotropic conductive film (not shown). FIG. 1B schematically illustrates the conventional placement of the scan, data driver chips 180a, 180b in the peripheral area 160 of the LCD panel.

In the foregoing assembly, the anisotropic conductive film may peel off, which affects the electric connection between the chips 180a, 180b and the connection terminals 170a, 170b. As a result, the reliability of the display system is altered.

Therefore, there is presently a need for a flat panel display assembly that can ensure an effective connection of the driver chips to the display panel, and thereby enhance the reliability of the display system.

### SUMMARY OF THE INVENTION

The present application describes a flat panel display and an assembly process that can improve the connection of the driver chips on the array substrate of the display system. In one embodiment, a flat panel display system comprises a plurality of connection terminals laid over the array substrate, at least two integrated circuit chips respectively connected with the connection terminals via an anisotropic conductive film, and one or more interface layer laid in an area between the two integrated circuit chips to promote adhesion of the anisotropic conductive film with the array substrate. Peeling effects of the anisotropic conductive film can be thereby alleviated.

In another embodiment, a process of assembling a flat panel display comprises forming at least first and second connection terminals over an array substrate, forming one or more interface layer on a surface of the array substrate in an area between the first and second connection terminals, and connecting at least two integrated circuit chips respectively with the first and second connection terminals via an anisotropic conductive layer. The anisotropic conductive film adheres on the interface layer in the area between the two integrated circuit chips.

In an embodiment, the connection terminal includes a terminal pad and a contact layer laid on the terminal pad, and the interface layer and the contact pad are made of a same material to provide a uniform material interface between the anisotropic conductive film, at one side, and the array substrate at the other side.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1A is a schematic view illustrating a conventional pixel array of a LCD system know in the art;

FIG. 1B is a schematic view showing the conventional assembly of integrated circuit drivers in the LCD panel;

FIG. 2A is a general view schematically illustrating a LCD pixel array structure according to an embodiment of the invention;

FIG. 2B is an enlarged view of an area of the pixel array between two data driver integrated circuit chips;

FIG. 2C is an enlarged view of an area of the pixel array between two scan driver integrated circuit chips;

FIG. 2D is a cross-sectional view taken along section 2D-2D as shown in FIGS. 2B and 2C;

FIGS. 3A˜3C are schematic views of an interface layer implemented according to variant examples of the invention; and

FIGS. 4A˜4E are schematic views of a process of assembling a flat panel display panel according to an embodiment of the invention.

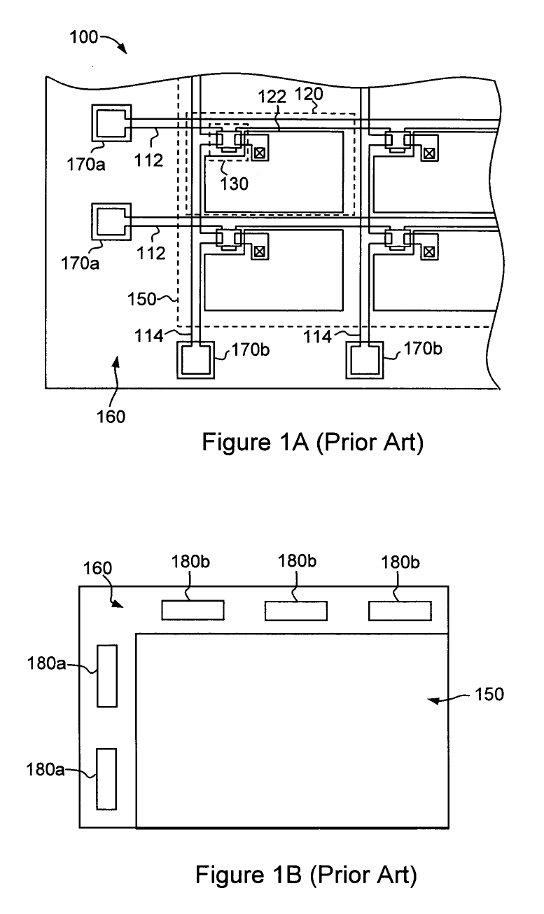

### DETAILED DESCRIPTION OF THE EMBODIMENT(S)

The application describes a flat panel display and an assembly process implemented in the manufacture of the flat panel display. For the purpose of illustration, a liquid crystal display is exemplary described herein, but it is understood that the inventive features described herein can be generally implemented in many types of flat panel display.

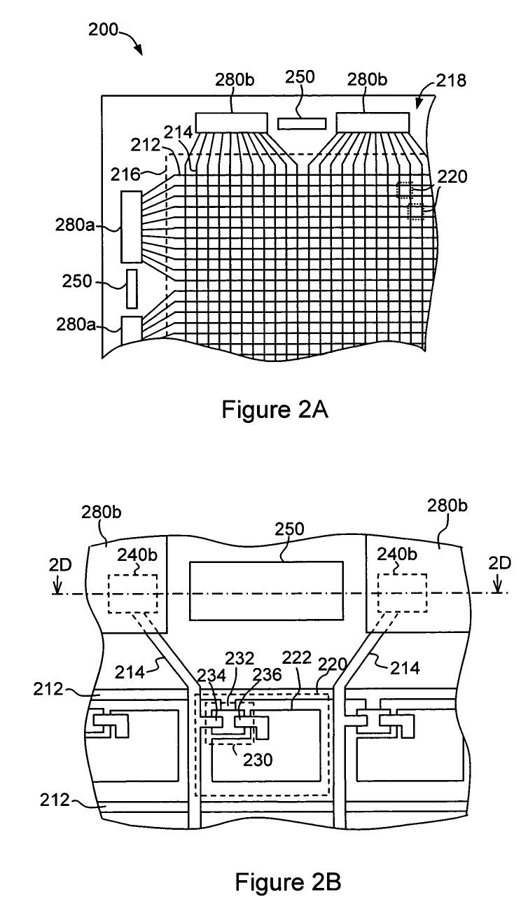

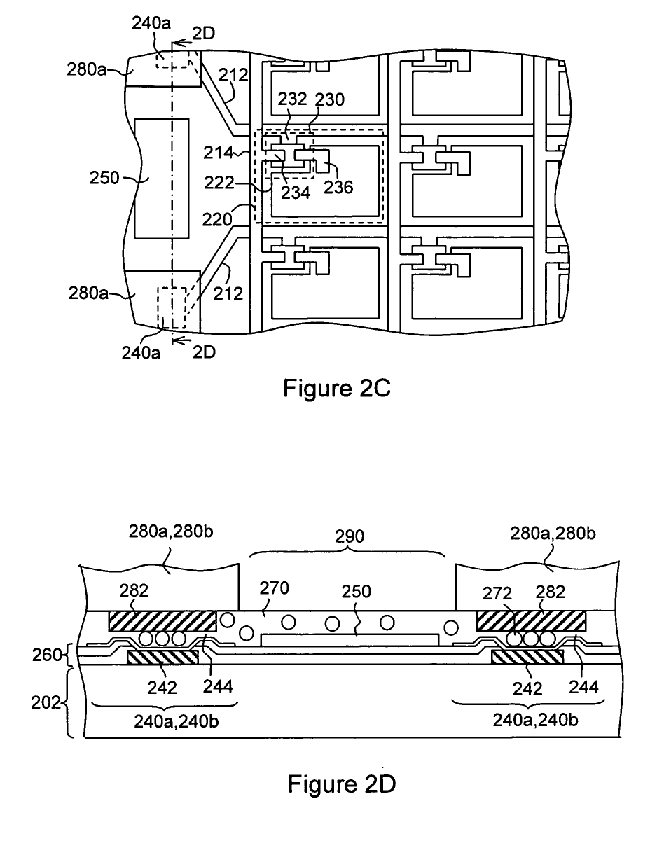

FIG. 2A is a planar view of a LCD panel constructed according to an embodiment of the invention. The LCD panel 200 includes a mesh of scan and data lines 212, 214 that defines an array of pixels 220 in a display area 216. The scan and data lines 212, 214 run and terminate in a non-display peripheral area 218 where they are connected with scan, data driver integrated circuit chips 280a, 280b, respectively. Each scan, data driver circuit 280a, 280b are coupled with a number of scan, data lines 212, 214.

FIG. 2B is an enlarged view showing an area of the LCD panel approximately between two data driver circuits 280b, while FIG. 2C is an enlarged view showing an area of the LCD panel approximately between two scan driver circuits 280a. In each pixel 220, a switching device 230 couples one pixel electrode 222 with one scan line 212 and one data line 214. The switching device 230 can be a thin film transistor having a gate electrode 232 connected to one scan line 212, a source electrode 234 connected to one data line 214, and a drain electrode 236 connected to the pixel electrode 222. The switching device 230 can thereby operate to input image signals to the pixel electrode 222 upon receiving addressing and image data signals delivered through the scan and data lines 212, 214, respectively.

The scan, data lines 212, 214 terminate in connection terminals 240a, 240b through which they are connected to the scan, data driver integrated circuit chips 280a, 280b, respectively. The scan, data driver integrated circuit chips 280a, 280b thereby can be operable to issue addressing and image data signals on the scan and data lines 212, 214 to selectively control the illumination or extinction of the pixels 220.

FIG. 2D is a cross-sectional view taken along a section 2D-2D as shown in FIGS. 2B and 2C. The scan, data lines 212, 214 are formed over an array substrate 202 provided with the array of pixels. The scan, data lines 212, 214 terminate in terminal pads 242 in the peripheral area 218. A layer of insulating material 260 formed over the terminal pads 242 includes opening through which contact layers 244 are laid to connect with the terminal pads 242.

One or more interface layer 250 is formed on the insulating layer 260 in an area 290 between two scan, data driver circuits 280a, 280b. An anisotropic conductive film 270 including conductive particles 272 is laid over the interface layers 250 and the connection terminals 240a, 240b to establish the electric connection with connection pads 282 of the scan, data driver integrated circuit chips 280a, 280b. The interface layers 250 thus provided can act to ensure an effective adhesion of the anisotropic conductive films 270 over the substrate array 202, and thereby prevent peeling of the anisotropic conductive film 270.

In an embodiment, the interface layer 250 can be made of a material similar to that constituting the contact layers 244 to provide a substantially uniform material interface between the anisotropic conductive film 270, at one side, and the surface of the array substrate 202 at the other side. Such a material can be a transparent conductive material such as indium tin oxide, indium zinc oxide or the like, deposited on the surface of the insulating layer 260. Notwithstanding, any types of material adequatelty selected to promote adhesion with the anisotropic conductive film can be generally suitable for the interface layers.

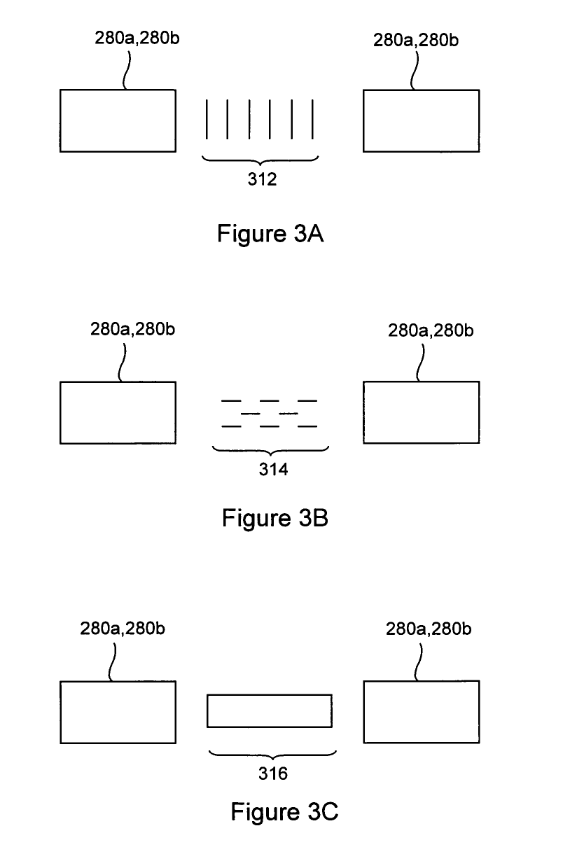

FIGS. 3A˜3C are schematic views of implementations of the interface layer according to various examples of the invention. The interface layer can be formed according to diverse patterns. FIG. 3A illustrates an interface layer formed in a pattern 312 of parallel segments between two integrated circuit chips 280a, 280b. In FIG. 3B, the pattern 314 includes segments distributed according to an alternated scheme. In FIG. 3C, the interface layer can be formed as a single stripe 316.

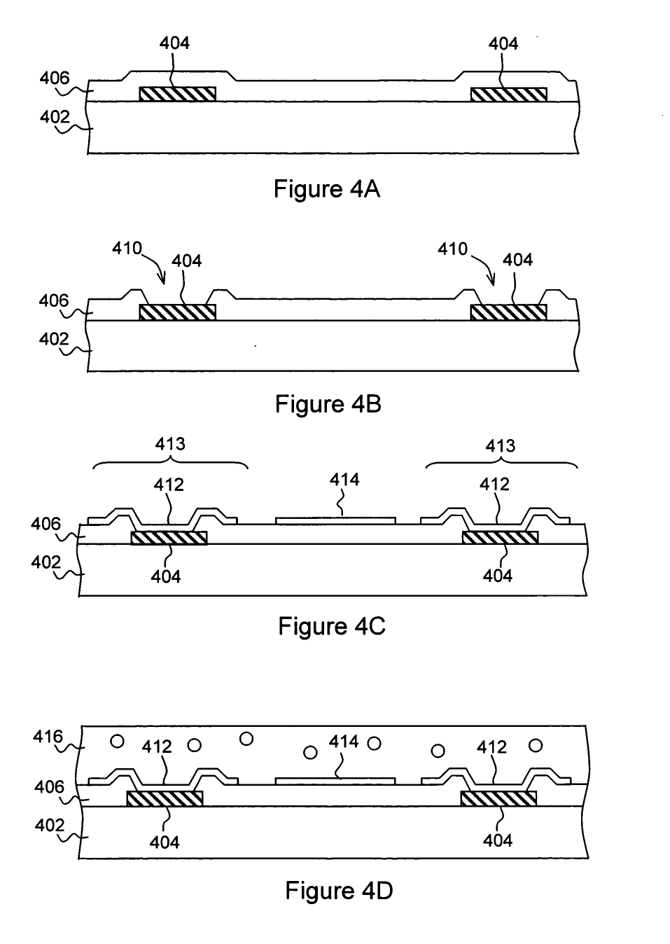

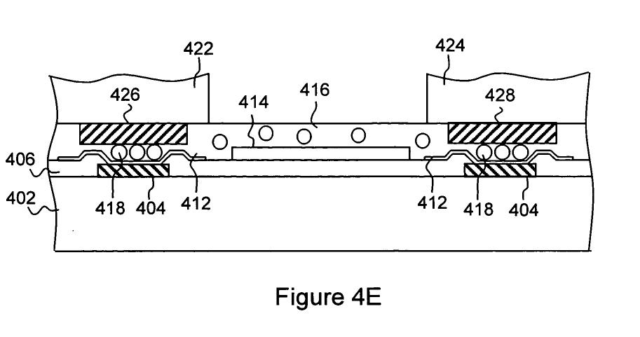

FIGS. 4A˜4E are schematic views of a process implemented in the assembly of driver chips in a flat display panel according to an embodiment of the invention. In FIG. 4A, terminal pads 404 are formed over a substrate 402. The terminal pads 404 can be made of a conductive metallic material connected with an electric circuitry such as a pixel array circuitry (not shown) formed over the substrate 402. A layer of insulating material 406 covers the terminal pads 404.

In FIG. 4B, the insulating layer 406 is patterned to form openings 410 that respectively expose the terminal pads 404. Patterning the insulating layer 406 can be achieved via etching through a pattern mask that exposes areas of the insulating layer 406 corresponding to the locations of the openings 410 (not shown).

In FIG. 4C, a conductive layer is formed over the insulating layer 406. The conductive layer is selectively etched to remove unnecessary material parts and form contact layers 412 that line the sidewalls of the openings 410 to contact with the terminal pads 404. The terminal pads 404 and contact layers 412 form connection terminals 413 through which the pixel array circuitry can be coupled with driver integrated circuit chips. In addition, an interface layer 414 is formed on the surface of the insulating layer 406 in an area between two neighboring connection terminals 413.

In an embodiment, the interface layer 414 can be formed from the same material as the contact layers 412. The interface layer 414 can be formed along with the contact layers 412 by patterning the conductive layer deposited over the insulating layer 406. Notwithstanding, the interface layer 414 can be generally made of any material suitable to promote the adhesion with an anisotropic conductive film as described later.

In FIG. 4D, an anisotropic conductive film 416 is formed over the substrate 402 to adhere on the contact layers 412 and the interface layer 414. The interface layer 414 thereby provides an adequate material interface that can prevent peeling effects.

In FIG. 4E, two driver integrated circuit chips 422, 424 are pressed on the anisotropic conductive film 416 while heating is applied thereon, so that conductive particles 418 inside the anisotropic conductive film 416 can electrically connect the two connection terminals 413 with respective connection pads 426, 428 of the two driver integrated circuit chips 422, 424.

It is understood that the above assembly method can be generally implemented in a large range of applications and is not restricted to the field of flat panel display manufacture.

Realizations in accordance with the present invention have been described in the context of particular embodiments. These embodiments are meant to be illustrative and not limiting. Many variations, modifications, additions, and improvements are possible to implement the inventive features described herein. Accordingly, plural instances may be provided for components described herein as a single instance. Additionally, structures and functionality presented as discrete components in the exemplary configurations may be implemented as a combined structure or component. These and other variations, modifications, additions, and improvements may fall within the scope of the invention as defined in the claims that follow.

1. A flat panel display system, comprising:
a plurality of connection terminals laid over an array substrate, wherein the connection terminals respectively couple with scan and data lines defining a pixel array over the array substrate;
at least two integrated circuit chips respectively connected with the connection terminals via an anisotropic conductive film; and
one or more interface layer laid in an area between the two integrated circuit chips to promote adhesion of the anisotropic conductive film with the array substrate.

2. The display system according to claim 1, wherein the interface layer is located on the surface of an insulating layer of the array substrate.

3. The display system according to claim 1, wherein the at least two integrated circuit chips are located in a non-display peripheral area of the array substrate.

4. The display system according to claim 1, wherein one or more connection terminal includes:
a terminal pad connected to one scan or data line;
an insulating layer having an opening exposing the terminal pad; and
a contact layer extending in the opening to contact with the terminal pad.

5. The display system according to claim 4, wherein the one or more interface layer and the contact layer are made of a same material.

6. The display system according to claim 5, wherein the one or more interface layer and connection terminals are made of a transparent conductive material including indium tin oxide, indium zinc oxide, or the like.

7. The display system according to claim 1, wherein the at least two integrated circuit chips include a scan driver integrated circuit chip and a data driver integrated circuit chip.

8. The display system according to claim 1, wherein the one or more interface layer is formed in a pattern of parallel segments.

9. A process of assembling a flat panel display, comprising:
forming at least first and second connection terminals over an array substrate;
forming one or more interface layer on a surface of the array substrate in an area between the first connection terminal and the second connection terminal; and
connecting at least two integrated circuit chips respectively with the first and second connection terminals via an anisotropic conductive layer, wherein the anisotropic conductive film adheres on the interface layer in the area between the two integrated circuit chips.

10. The process according to claim 9, wherein forming first and second connection terminals over an array substrate comprises:
forming first and second terminal pads over the array substrate;
forming an insulating material covering the first and second terminal pads;
patterning the insulating material to form openings that expose the first and second terminal pads, respectively; and
forming a plurality of contact layers that respectively extend in the openings to contact with the first and second terminal pads.

11. The process according to claim 10, wherein the one or more interface layer and the contact layers are made of a same material.

12. The process according to claim 11, wherein the one or more interface layer and the contact layers are made of a transparent conductive material including indium tin oxide, indium zinc oxide, or the like.

13. The process according to claim 9, wherein forming at least first and second connection terminals and forming one or more interface layer on the surface of the array substrate further comprises:
forming first and second terminal pads over the array substrate;
forming an insulating material covering the first and second terminal pads;
patterning the insulating material to form openings that expose the first and second terminal pads, respectively;
forming a conductive layer over the array substrate; and
patterning the conductive layer to form contact layers respectively extending in the openings to contact with the first and second terminal pads, and an interface layer located in an area between the contact layers.

14. The process according to claim 9, wherein coupling at least two integrated circuit chips respectively with the first and second connection terminals via an anisotropic conductive layer laid over the connection terminals comprises:
laying the anisotropic conductive film on the one or more interface layer and the first and second connection terminals; and
pressing the two integrated circuit chips on the anisotropic conductive film and heating the anisotropic conductive film to establish electric connection between the two integrated circuit chips and the first and second connection terminals, respectively.

15. The process according to claim 9, wherein forming one or more interface layer on the surface of the array substrate further comprises patterning the one or more interface layer into a plurality of parallel segments.

16. The process according to claim 9, wherein the at least two integrated circuit chips include a scan driver integrated circuit chip and a data driver integrated circuit chip.
